(19) United States
(12) Patent Application Publication
(10) Pub. No.: US 2017/0186071 A1
(43) Pub. Date: Jun. 29, 2017

(54) SYSTEM AND METHOD FOR BROKERED DELIVERY OF THREE-DIMENSIONAL OBJECTS

(71) Applicants: Kabushiki Kaisha Toshiba, Minato-ku (JP); Toshiba TEC Kabushiki Kaisha, Shinagawa-ku (JP)

(72) Inventor: Kevin Dodd, Irvine, CA (US)

(21) Appl. No.: 14/981,126

(22) Filed: Dec. 28, 2015

(51) Int. Cl. G06Q 30/06; B29C 67/00; G05B 19/4099; G06Q 30/02

(52) U.S. Cl. CPC G06Q 30/0633; G06Q 30/0283; B29C 67/0088; G05B 19/4099; G05B 2219/35134; G05B 2219/49007; B33Y 50/02

(57) ABSTRACT

A system and method facilitates brokered delivery of three-dimensional objects. A networked computing device sends an object description file to a broker with a request to initiate a rendering of an object defined by the object description file at a designated destination. The broker server relays the object description file to a rendering device at the designated destination, such as a three-dimensional printer, which commences rendering the object. Senders and recipients can register with the broker prior to transmission of the object description file. The broker can charge a fee associated with the transaction.

### TECHNICAL FIELD

This application relates generally to network printing services. The application is particularly applicable to networked object delivery via networked three-dimensional fabrication devices.

### BACKGROUND

Gifting or sale of objects has occurred for countless years. Initially, an object would be physically brought to a recipient. More recently, governmental mail delivery was used as a way to send an object to a recipient without having to deliver it personally. Even more recently, private delivery firms, such United Parcel Service, FedEX, DHL, or the like are used to send an object to a recipient. Advances in transportation and logistics have facilitated next day or overnight delivery options. In each instance, an existing object is conveyed to the recipient.

Traditional manufacturing of products occurs in several different ways. Each commences with raw materials from which an object will be fabricated. For example, a block or sheet of malleable material may be formed by application of pressure. An early example is a blacksmith forming a metal object by heating and beating with a hammer.

In another example, objects are formed by use of a die and a stamping machine. Solid object can also be fabricated from solidifying material placed in a mold or manipulated with pressure, such as with glass blowing or pottery making. A dominant form of manufacturing objects, particularly those that are not mass produced, is by a subtractive manufacturing process. That is, the process commences with a solid block of material. Material is removed from the block in such a fashion as to result in an object with a desired shape. Examples range from wood carving through machining with lathes, milling machines, drills, sanders or the like.

If one desires to transfer a particular object to another, then they must first make or obtain the object and then deliver it, or have it delivered to the recipient. For unique or personal items, one would first need to make it, or have it made, in a fashion as noted above. Often times one does not want the recipient to immediately be able to identify an object, such as when the object is a gift or surprise. Traditionally, this is facilitated by wrapping an object so as to require it to be opened by the recipient. Similarly, an object that is sent via mail or other delivery service is typically wrapped or boxed, allowing a recipient to be surprised upon opening or unwrapping.

### SUMMARY

In accordance with an example embodiment, a system or method for brokering a sender's request to remotely render a three-dimensional object on a recipient's fabricator, such as a three-dimensional printer, includes a processor and associated memory. A broker server receives a job request, design description data and address information from the sender for constructing a selected three-dimensional object on a designated recipient's three-dimensional printer. The broker server outputs a start instruction to the recipient's three-dimensional printer to commence fabrication of the selected three-dimensional object in accordance with the fabrication instructions.

In accordance with another example embodiment, the broker server assesses a fee for brokering a three-dimensional printing request.

In accordance with another example embodiment, the broker server limits transactions to situations when one or both of the sender and the recipient are registered or give permission for transmission or receipt of three-dimensional printing requests.

### BRIEF DESCRIPTION OF THE DRAWINGS

Various embodiments will become better understood with regard to the following description, appended claims and accompanying drawings wherein:

FIG. 1 is a diagram of an example embodiment of a brokered object delivery system;

FIG. 2 is a block diagram of an example embodiment of a hardware platform of a 3D printer or other digital computing device;

FIG. 3 is a is a block diagram of an example embodiment of broker activity;

FIG. 4 is a flowchart of an example embodiment of sender activity;

FIG. 5 is a flowchart of an example embodiment of broker activity;

FIG. 6 is a flowchart of an example embodiment of recipient activity; and

FIG. 7 is a flowchart of an example embodiment of a fee based, brokered object delivery.

### DETAILED DESCRIPTION

Traditionally, transfer of objects to recipients requires the physical delivery of an existing object via in-person or third-party delivery. Unique items are fabricated and typically boxed or wrapped prior to transfer. Today, physical objects can be defined digitally. Objects can be created by computer aid design (CAD) and created by computer aided manufacturing (CAM). Earlier CAD/CAM employed conventional manufacturing techniques, typically a subtractive rendering process such as those noted above. It will be appreciated by one of ordinary skill in the art that the disclosure herein is applicable to analogous rendering by any numerically-controlled fabrication system, such as lathes, milling machines, and the like. More recently, manufacturers have begun employing additive manufacturing. That is, rather than removing material to create an object, material is added to form an object. Recent developments include what is referred to as three-dimensional printing or 3D printing. 3D printing uses one or more print nozzles that are configured for motion along three axes. Instead of ink, the nozzles exude semi-solid material deposited in layers that suitably hardens after deposition. Coordinated three-dimensional movement of the nozzle or nozzles, coupled with selective activation of deposition via the nozzles, is used to build a three-dimensional object. Unlike typical numerically controlled manufacturing devices, 3D printing devices have become increasingly capable with ever decreasing production costs, enabling them to be a suitable platform for brokered object renderings.

Advantages of 3D printing include little or no wasted material, such as would occur during subtractive manufacturing, and an ability to quickly render objects from various materials with minimal production costs and with no requirement of maintaining a physical inventory. 3D printing devices and techniques are growing increasingly sophisticated and less expensive. Accordingly, 3D printers are also becoming more ubiquitous, and are becoming appliances found in more homes.

Stereolithography (SL) is one of several methods used to create 3D-printed objects. With it, a device, called a stereolithograph apparatus (SLA), converts liquid plastic into solid objects. 3D printing materials have grown to also include metal, ceramics, and even foodstuffs.

There are many different ways to print a 3D object. Most implement CAD files. There are many available CAD file types. Commonly used ones include AutoCAD DXF, ISO 10303, ISO 13399, IGES, KernelCAD, or the like.

In 3D printing, CAD files are typically translated into a language or file type understood by 3D printers. One example file type is Standard Tessellation Language (STL). Since additive manufacturing works by adding one layer of material on top of another, CAD models are typically divided into layers for 3D printing.

An example 3D printer includes a tank that can be filled with a base manufacturing substance, such as a polymer plastic. In a particular example embodiment, the polymer plastic is comprised of a photopolymer. A platform is disposed in an enclosure and is moveable relative to the printer unit. Deposition is suitably accomplished in conjunction with an ultraviolet (UV) laser, and functions are governed by a computerized controller.

The example 3D printing process commences with deposition of a thin layer of photopolymer, typically between 0.05-0.15 mm, on the platform. The UV laser is directed to the material on platform, “painting” a pattern of the object being printed. The photopolymer is ultraviolet (UV) curable, and the deposited liquid hardens when exposed to the UV. This forms the first layer of the 3D-printed object. Subsequent layers are deposited similarly on a previous layer until the full object is physically rendered. It will be appreciated that any suitable deposition system can be implemented, including materials that harden by air drying, cooling, etc.

In the example embodiment, the object is suitably is rinsed with a liquid solvent to free it of excess resin and then heated or treated in an ultraviolet oven to further cure the plastic.

In an example embodiment, a suitable 3D printer is connected with a data network, such as a local area network (LAN), wide area network (WAN) or the Internet, or a combination thereof. This network connection facilitates sending of an object to a networked 3D printer, allowing for rendering of the object without the recipient knowing any details. By way of example, a 3D object may be a surprise for a special event. The recipient would not see the object until rendered by their 3D printer, and may even enjoy watching the 3D printing process as their mystery gift is created.

During the period when facsimile usage became ubiquitous, a serious problem developed relative to what is referred to as “junk faxes.” That is, a fax machine owner would periodically receive faxes from marketers or scammers that had no prior relationship with the owner. Junk faxes were frequently disguised as purchase renewals, re-orders or reminders for orders, all of which were non-existent. Not only were such faxes deceptive, fax communication places costs of receipt, such as paper, ink and machine usage, solely on the recipient. This problem was so prevalent that the United States passed the Junk Fax Prevention Act of 2005 which provide severe penalties to those sending junk faxes.

The subject application implements a third-party broker system to facilitate networked delivery of 3D objects via an end user's 3D printer which minimizes opportunity for receipt of unwanted object by providing pre-authorization by potential recipients so that object are received in connection with their own desires and terms.

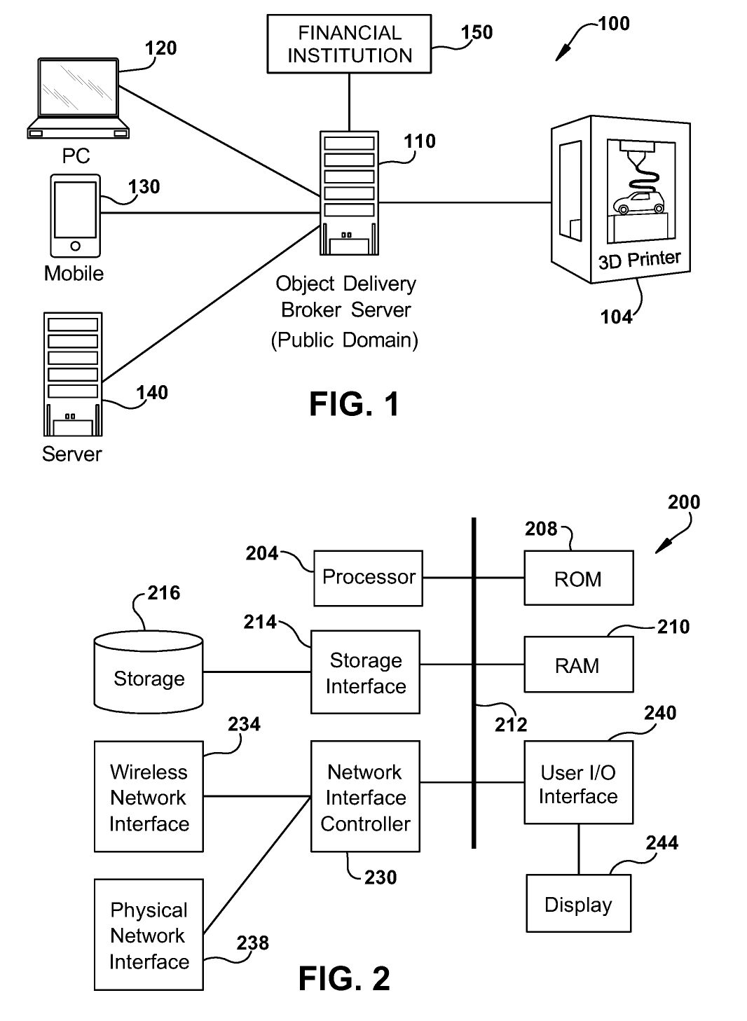

Turning to FIG. 1, illustrated is a 3D object delivery system 100. The system 100 includes one or more 3D printers, such as 3D printer 104. Each 3D printer 104 is in data communication with an object delivery broker server 110. It will be appreciated that a suitable broker server 110 may be distributed over two or more coordinated systems which may be distributed among multiple locations. An example embodiment of a broker server 110 will be detailed below. Suitable data paths between the 3D printer 104 and the broker server 110 include networked data paths such as that described above. It will be appreciated that any suitable data path, wireless or wired, permanent or situational, can be suitably implemented as will be appreciated by one of ordinary skill in the art.

Broker server 110 is in data communication with any suitable digital device via any suitable means as described above. Representative devices include computers, such as personal computer (PC) 120, mobile devices, such as laptop computers, notebook computers, tablet computers or smart phones, such as illustrated by mobile device 130, or a server, or server system, such as that illustrated by server 140. Broker server 110 is also in analogous data communication with a financial institution 150 to facilitate fee-based services as will be described in further detailed below. A suitable financial institution includes banks, credit agencies, or services such as PayPal. It will be appreciated that any suitable fee capture system may be implemented, such as prepaid credits. Fees suitably cover costs for brokering the printing transaction. Optionally, fees may include a reimbursement to an object recipient for costs to the recipient associated with completing the 3D printing operation.

Turning now to FIG. 2, illustrated is an example of a digital processing system 200 suitably included in a 3D printer. Included are one or more processors, such as that illustrated by processor 204. Each processor is suitably associated with non-volatile memory, such as ROM 208 and random access memory (RAM) 210, via a data bus 212.

Processor 204 is also in data communication with a storage interface 214 for reading or writing to a storage 216, suitably comprised of a hard disk, optical disk, solid-state disk, cloud-based storage, or any other suitable data storage as will be appreciated by one of ordinary skill in the art.

Processor 204 is also in data communication with a network interface controller (NIC) 230 which provides a data path to any suitable data path, including a wireless data connection via wireless network interface 234 or a physical network via physical network interface 238. Example wireless connections include cellular, WiFi, Bluetooth, near-field communication, wireless universal serial bus (wireless USB), satellite, and the like. Example wired interfaces include Ethernet, USB, IEEE 1394 (FireWire), or the like.

Processor 204 is also in data communication with a user input/output (I/O) interface 240 which provides data communication with user peripherals, such as display 244, keyboards, mice, track balls, touch screens, or the like.

It will be appreciated by one of ordinary skill in the art that the components of a digital processing system 200 such as that illustrated with particular reference to FIG. 2, are suitably included within digital data devices such as broker server 110, PC 120, mobile device 130 or server 140.

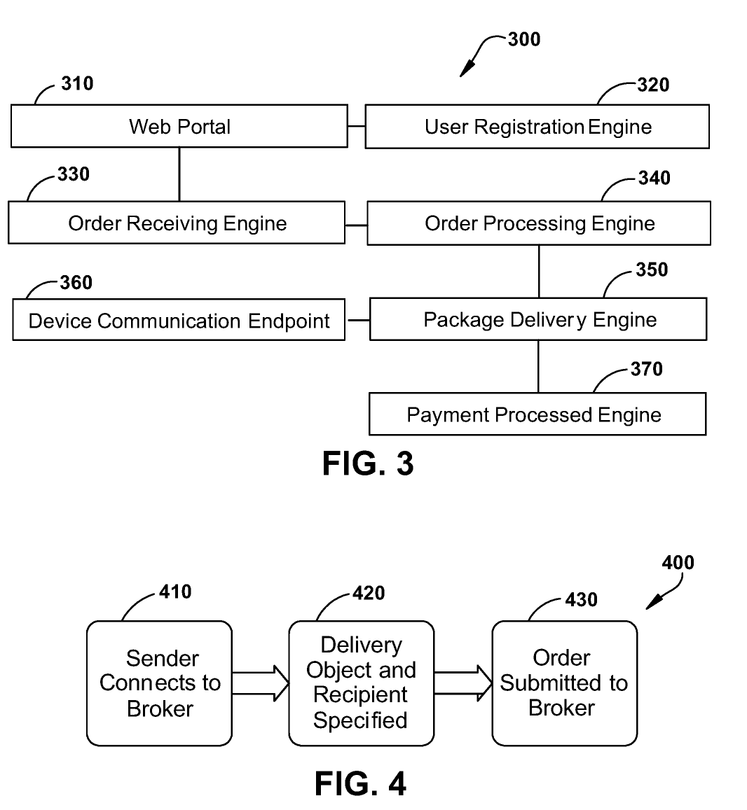

Referring now to FIG. 3, illustrated is an example block diagram for a broker operational module 300 of broker server 110. A network data connection is suitably provided via an Internet web portal 310. Users of the subject system include those users sending an object description to another for 3D printing, as well as those associated with one or more 3D printers that are potential targets for receiving 3D objects. A user registration engine 320 is configured to store user registration information for senders and recipients. User registration is desirable for transmission and receiving safeguards to avoid problems such as those described above. A potential object recipient would agree to use of their resources to engage in a third-party 3D printing of an object. A recipient may also give a list of those approved for sending 3D renderings, which is realized by registration of possible senders. Additional advantages of sender registration include potentially deregistering problematic senders, inactive parties or those who have defaulted relative to payment. Additional advantages of target printer registration include registration of printer properties to determine compatibility with print request.

With continued reference to FIG. 3, illustrated is order receiving engine 330, suitably configured to process orders for commencing a 3D printing operation for a recipient. When a print order is received and when appropriate, it is processed through order processing engine 340. Processing engine 340 suitably accomplishes charging fees as appropriate, scheduling, or any other suitable action that may be desired prior to actually commencement of a 3D printing package to one or more target printers. Processed orders are relayed to package delivery engine 350 which accomplishes communication with a target printer to commence a 3D object rendering. The subject system suitably checks for compatibility between the file format of the sender's order relative to compatibility of a target printer. If the two are incompatible, the system may reject the order or translate the order into a file type acceptable to the target printer.

Operational module 300 also suitably includes device communication endpoint 360 which facilitates communication with ordering devices or target devices, including those device communications detailed above.

Operation module 300 also suitably includes payment processing engine 370 for calculating fees for requested operations, assessing fees and securing payment such as with financial institution 150 as detailed above.

Turning now to FIG. 4, illustrated is a flowchart of an example embodiment of sender activity 400 associated with a sender's interaction with a broker, such as the broker server 110 of FIG. 2 as detailed above, to commence the sending of an object for 3D printing. In the illustrated process, a sender commences an operation by establishing a data connection to a broker at 410. Next, a delivery object and information relative to each recipient thereof is specified at 420. Next, an order is submitted to a broker at 430. The order is suitably accompanied by a fee amount to be leveled relative to the sender's request. This fee is suitably fixed, or varied depending on circumstances such as number of printings, print materials used, translation of file formats, or the like.

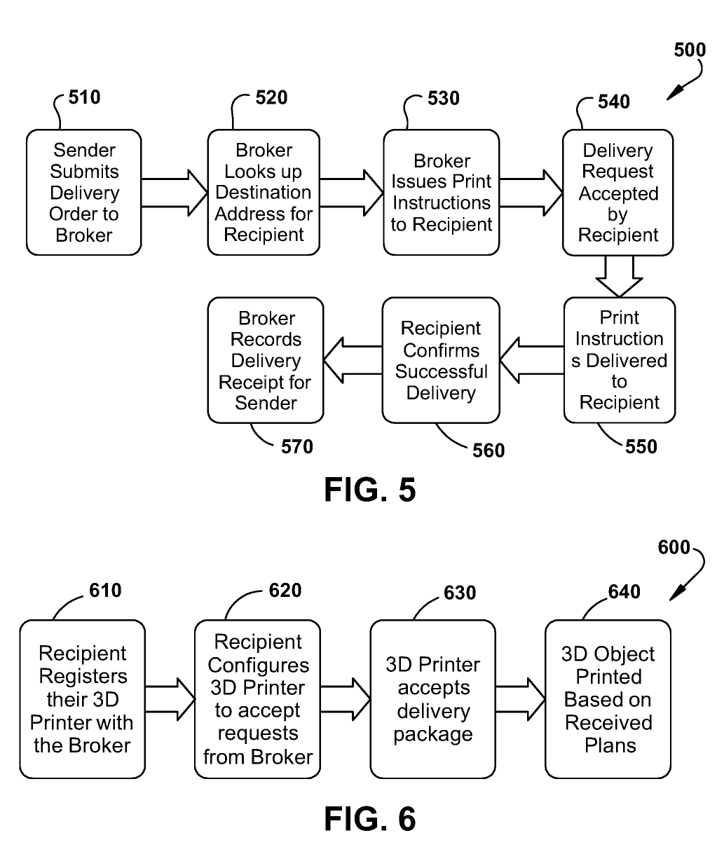

FIG. 5 illustrates a flowchart of an example embodiment broker delivery flowchart of broker activity 500. In the illustrated process, a sender submits a delivery order to a broker at 510. After receipt, the broker looks up a destination address for each designated recipient at 520. As detailed above, recipients are advantageously pre-registered to accept object printing. Next, a broker issues print instructions to each recipient at 530. This may include translation between sender file format and a format acceptable to each individual destination printer, which information is suitably gathered during registration, or alternatively, during a polling of a destination printer as part of the transmission process. Next, at 550, printing instructions are delivered to each recipient at 560. A recipient confirms successful delivery and/or printing at 560 and the broker records the same and suitably delivers a receipt to the sender at 570. This information is also suitably used in connection with fee assessment that may be leveled by the broker.

FIG. 6 illustrates a flowchart of an example embodiment of recipient activity 400 associated with a recipient of a 3D printed object. The recipient registers their 3D printer, suitably including address or other identification data, with the broker at 610. Next, the recipient configures each registered 3D printer as needed to accept printing requests from the broker at 620. Each designated recipient's 3D printer accepts delivery of a printing package at 630, and a 3D object printed based on the received plans is completed at 640. Optional confirmation, as detailed above, is suitably made to the broker relative to the operation, which confirmation may be relayed in whole or in part to the sender and may be used in connection with fee calculation.

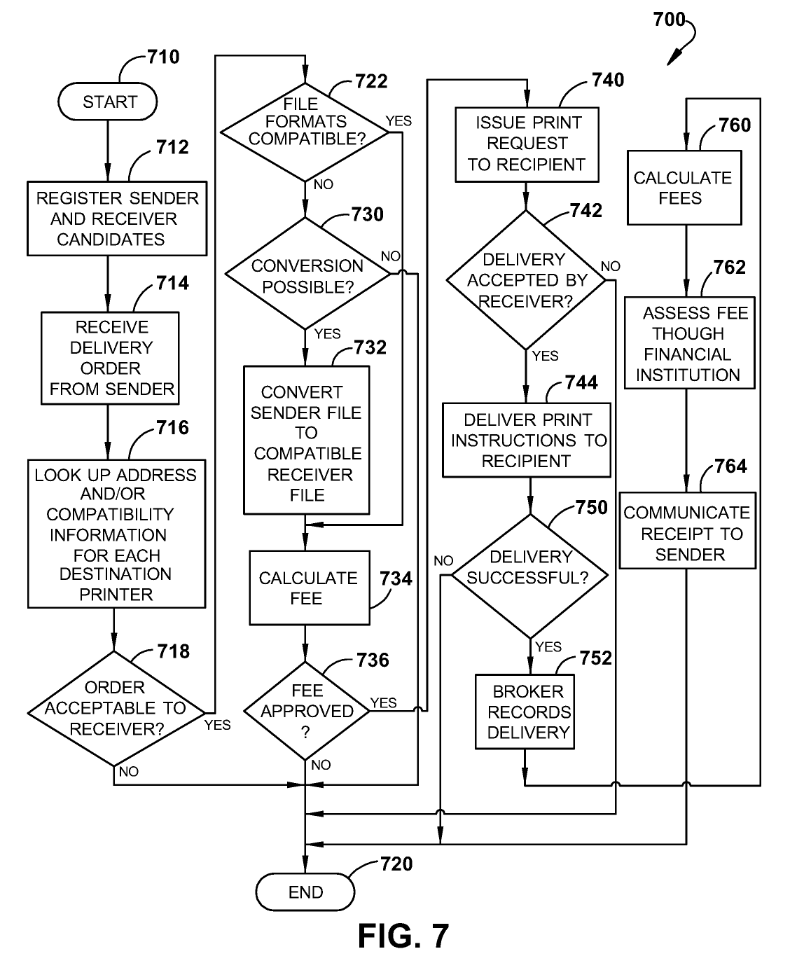

FIG. 7 is a flowchart of an example embodiment of a flow chart for handling brokered requests between a sender and a recipient for a 3D printing operation. The process commences a block 710. Sender and/or recipient candidates register with the broker at block 712. The broker receives a delivery order from the sender at block 714 comprising a request for 3D printing and address information associated with one or more target recipient's 3D printers, or any other suitable identifying information. The broker suitably looks up address and/or compatibility information for each designated 3D printer at block 716. An order is suitably analyzed to see if the recipient will accept printing requests from the sender at block 718. If not, the process is suitably aborted at block 720. Any termination or job aborting at block 720 may be accompanied with a notice to the sender, the recipient or both. If the recipient will accept 3D printing requests from the sender, compatibility between the sender's file format and the recipient's 3D printer is checked at block 722. If they are compatible, a fee for the service is suitably calculated at block 734. If not, a check is suitably made at block 730 to determine whether a conversion to a compatible file descriptor is possible. If not, the process is suitably aborted at block 720. If so, a conversion is made at block 732, and the process proceeds to block 734 for fee calculation. Once a fee is calculated, approval may be sought from the sender at block 736. It will be appreciated that a sender, as an initiator of a 3D print request, is more likely an appropriate candidate for fee payment. In certain instances, it may be desirable for a recipient to assume some or all of the fees. As with sender-based fees, this suitably occurs either by explicit acceptance or prior authorization.

Fee approval is obtained when appropriate at block 736. If requisite approval is not obtained, the process is suitably aborted at block 720.

Commencement of a 3D printing operation is made at by initiating a print request at block 740. The recipient can accept delivery for the printing operation at block 742, for example by a prior authorization by the recipient. Approved 3D printing operations facilitate transfer of print or fabrication instructions to each selected and approved destination at block 744.

Each destination printer suitably confirms successful delivery at block 750. If delivery is not successful, the process is suitably aborted at block 720, with optional notice of failure given to the sender or the intended recipient or recipients. Successful deliveries are suitably recorded by the broker at block 752. Fees are assessed for successful operations at block 760, and payment is suitably made with a suitable financial institution at block 762. By way of example, suitable payment processing center may be used, such as a bank, credit agency, or third party payment service such as PayPal or a debit may be made of prepaid credits. A receipt, such as an electronic receipt, is suitably sent to the sender at block 764. A receipt may also be sent to the recipient, particularly in situations where the recipient is funding all or part of the brokered operation.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the spirit and scope of the inventions.

What is claimed is:

1. A system comprising:
a processor and associated memory; and
a network interface configured to receive job request data corresponding to a job request to commence a three-dimensional printing operation,
wherein the network interface is configured to receive design data corresponding to construction of a selected three-dimensional object rendering from an associated, networked data device,
wherein the memory is configured to store received design data,
wherein the network interface is further configured to receive target data corresponding to an identity of at least one delivery target associated with the design data,
wherein the memory is further configured to store address data corresponding to a network address of a three-dimensional printer associated with the delivery target,
wherein the network interface is further configured to communicate fabrication instructions to the three-dimensional printer in accordance with the address data, and
wherein the network interface is further configured to output a start instruction to the three-dimensional printer to commence fabrication of the selected three-dimensional object in accordance with the fabrication instructions.

2. The system of claim 1 wherein the processor is configured to calculate a fee associated with processing of the job request.

3. The system of claim 2 wherein the network interface is further configured to communicate a fee calculation to an associated payment processing center.

4. The system of claim 1 wherein the network interface is further configured to receive a printer registration request corresponding to the three-dimensional printer, and
wherein the processor is configured to output the fabrication instructions in accordance with a received printer registration request.

5. The system of claim 4 wherein the processor is further configured to generate the fabrication instructions in accordance with a property of a registered three-dimensional printer.

6. The system of claim 1 wherein the network interface is further configured to communicate confirmation data to the networked data device corresponding to a commenced fabrication of the three-dimensional object to the networked data device.

7. The system of claim 6 wherein the network interface is further configured to receive completion data corresponding to a successful completion of fabrication of the three-dimensional object by the three-dimensional printer.

8. A method comprising:
receiving, via a network interface, job request data corresponding to a job request to commence a three-dimensional printing operation;
receiving, via the network interface, design data corresponding to construction of a selected three-dimensional object rendering from an associated, networked data device;
storing received design data in a memory;
receiving, via the network interface, target data corresponding to an identity of at least one delivery target associated with the design data;
storing address data corresponding to a network address of a three-dimensional printer associated with the delivery target in the memory;
communicating, via the network interface, fabrication instructions to the three-dimensional printer in accordance with the address data; and
communicating, via the network interface, a start instruction to the three-dimensional printer to commence fabrication of the selected three-dimensional object in accordance with the fabrication instructions.

9. The method of claim 8 further comprising:
calculating, via a processor, a fee associated with processing of the job request.

10. The method of claim 9 further comprising:
communicating data corresponding to a fee calculation to an associated payment processing center.

11. The method of claim 8 further comprising:
receiving, via the network interface, a printer registration request corresponding to the three-dimensional printer; and
generating, via a processor, fabrication instructions in accordance with a received printer registration request.

12. The method of claim 11 further comprising:
generating, via a processor, the fabrication instructions in accordance with a property of a registered three-dimensional printer.

13. The method of claim 8 further comprising:
communicating, via the network interface, confirmation data to the networked data device corresponding to a commenced fabrication of the three-dimensional object to the networked data device.

14. The method of claim 14 further comprising:
receiving, via the network interface, completion data corresponding to a successful completion of fabrication of the three-dimensional object by the three-dimensional printer.

15. A system comprising:
a processor and associated memory; and
a network interface configured to receive registration data corresponding to a registration request for registration each of a plurality of networked three-dimensional printers,
wherein the processor is configured to selectively register networked three-dimensional printers in accordance with each received registration request,
wherein the network interface is configured to receive job request data from an associated, networked data device corresponding to a request to commence a three-dimensional printing operation at one or more registered three-dimensional printers,
wherein the network interface is further configured to receive, from the networked data device, design data corresponding to construction of a selected three-dimensional object rendering,
wherein the memory is configured to store received design data,
wherein the network interface is further configured to receive, from the networked data device, target data corresponding to an identity of at least one delivery target associated with the design data,
wherein the memory is further configured to store address data corresponding to a network address of each three-dimensional printer associated with the delivery target,
wherein the network interface is further configured to communicate fabrication instructions to each three-dimensional printer in specified by the address data, and
wherein the network interface is further configured to communicate a fabrication instruction to each three-dimensional printer specified by the address data.

16. The system of claim 15 wherein the network interface is further configured to receive the registration data including data corresponding to properties of a printer associated therewith, and
wherein the processor operable to generate the fabrication instructions in accordance with the design data and the registration data.

17. The system of claim 15 wherein the fabrication instructions are comprised of the design data.

18. The system of claim 15 wherein the network interface is further configured to receive payment data corresponding to the job request data,
wherein the processor is further configured to calculate fee data associated with processing of the request to commence a three-dimensional printing operation, and
wherein the network interface is further configured to communicate the fee data to an associated payment processor.

19. The system of claim 15 wherein the network interface is further configured to receive job progress data from each three-dimensional printer specified by the address data, and
wherein the network interface is further configured to communicate report data corresponding to received job progress data to the networked data device.

20. The system of claim 15 wherein the network interface is further configured to receive confirmation data for each three-dimensional printer specified by the address data, and
wherein the processor is further configured to generate the fabrication instruction in accordance with received confirmation data.
